(19) United States
(12) Patent Application Publication
(10) Pub. No.: US 2007/0018644 A1
(43) Pub. Date: Jan. 25, 2007

(54) Signal processing for detection of nqr signals

(76) Inventors: John Harold Flexman, WESTERN AUSTRALIA (AU); Warrick Paul Chisholm, Western Australia (AU); Peter Alaric Hayes, Western Australia (AU); Vassili Timofeevitch Mikhaltsevitch, Western Australia (AU); Taras Nikolaevitch Rudakov, Western Australia (AU)

Correspondence Address: PILLSBURY WINTHROP SHAW PITTMAN, LLP, P.O. BOX 10500, MCLEAN, VA, 22102, US

(21) Appl. No.: 10/543,771

(22) PCT Filed: Jan. 30, 2004
(86) PCT No.: PCT/AU04/00109

§ 371 Date: May 25, 2006

(30) Foreign Application Priority Data
Jan. 30, 2003 (AU) 2003900418

(51) Int. Cl. G01V 3/00

(52) U.S. Cl. 324/307

(57) ABSTRACT

A method for analysing signals received from an object. The method initially comprises deriving the parameters of frequency and phase of said signals in either the time domain or frequency domain. It then comprises identifying whether the signals conform to a linear relationship between the two parameters to ascertain whether a true signal representative of a character of the object is present. The character may be a nuclear or electronic resonance, such as NQR, NMR or ESR, which is indicative of a particular substance. Signal processing methods involving HTLS, HSVD, MPM, MMPM, FFT, STFT and STMPM are also described.

### FIELD OF THE INVENTION

This invention relates to improvements in signal processing for the detection of signals emanating from Nuclear Quadrupole Resonance (NQR), Nuclear Magnetic Resonance (NMR) or Electron Spin Resonance (ESR). This invention may also be applicable to other spectroscopic methods and fields which require the analysis of signals.

Throughout the specification, unless the context requires otherwise, the word “comprise” or variations such as “comprises” or “comprising”, will be understood to imply the inclusion of a stated integer or group of integers but not the exclusion of any other integer or group of integers.

### BACKGROUND ART

The following discussion of the background art is intended to facilitate an understanding of the present invention only. It should be appreciated that the discussion is not an acknowledgement or admission that any of the material referred to is or was part of the common general knowledge as at the priority date of the application.

The traditional processing method for signals derived from NQR, NMR & ESR utilises the Fourier Transform (FT) to transform the time domain signal into the frequency domain. As well as the FT there are other methods which can transform the data into the frequency domain. These methods include the Short Time Fourier Transform (STFT), wavelets, maximum entropy method etc. Recently matrix processing methods have become available which are able to extract the most significant parameters of a signal without transforming the signal into the frequency domain. Such methods have been called ‘Statistical Time Domain Methods (STDMs)’. Some of the matrix processing methods include Estimation of Signal Parameters via Rotational Invariance Techniques (ESPRIT), Linear Prediction (LP), Hankel Total Least Squares (HTLS), Hankel Single Value Decomposition (HSVD), Matrix Pencil Method (MPM), Modified Matrix Pencil Method (MMPM) and Matrix Pencil-Fourth Order Cumulant (MPFOC).

Linear Prediction using a single value decomposition (SVD) approach generally involves constructing a linear prediction matrix and using the SVD to determine the signal parameters.

The ESPRIT sub space method relies on the eigendecomposition of the sample covariance matrix to determine the signal parameters.

Other matrix processing methods can include the HSVD state space method, which utilises the removal of the top and bottom row of the linear prediction matrix to determine the signal parameters, and the sub space HTLS method. The HTLS is a variant of the HSVD method and uses total least squares to determine the signal parameters.

One of the more promising techniques is the matrix pencil method, which can extract undamped/damped sinusoids from noisy signals. As the name suggests this technique utilises a matrix pencil or a linear combination between two matrices to determine signal parameters.

The MPM can be applied to processing in Nuclear Magnetic Resonance (NMR), Nuclear Quadrupole Resonance (NQR), Electron Spin Resonance (ESR), and Magnetic Resonance.

By utilising the matrix pencil method with a pre-processing step of iteratively reducing the linear prediction matrix to a hankel type matrix, the influence of noise upon the signal parameters may be reduced.

Lastly, the MPFOC method combines higher order statistics and the matrix pencil method to reduce the influence of Gaussian noise on signal parameters.

In NQR, a sample to be analysed for the presence of NQR sensitive nuclei is irradiated with one or more pulses of radiofrequency radiation delivered via a conductive coil resonant at the nuclei's NQR transition frequency. The same coil or another coil receives the induced signal from the sample and this signal is measured as a voltage across the coil.

The measured voltage level is digitised by sampling at a regular interval and this sampled signal is then processed by mathematical software. In an NQR detection device, software would be required to determine whether there was a signal of interest present or not.

Traditionally, processing performed by the software would require that the signal be filtered to remove some unwanted noise and baseline corrected to remove any upward or downward trends in the data. Apodisation of the data can also reduce the influence of noise.

After these pre-processing steps have been completed, the signal can be Fast Fourier Transformed (FFT) to convert time domain data into the frequency domain. The peak frequency, peak height and phase parameters are compared to known signal parameters. If the amplitude or the peak height crosses a specified threshold, then the signal is considered to be a validly detected NQR signal.

When using the FFT, the signal is modelled as a series of undamped sinusoids. In matrix processing methods, the signal received by an NQR device is modelled as a series sum of damped/undamped sinusoids, as indicated in the equations below:

$$\begin{matrix}Y ( k ) = x ( k ) + n ( k ) & ( 1 ) \\ Y ( k ) = {\sum }_{I = 1}^{M} \vert {b}_{i} \vert \cdot {ⅇ}^{( ( {α}_{i} {jω}_{i} ) k + {jϕ}_{i} )} + n ( k ) & ( 2 ) \\ Y ( k ) = {\sum }_{I = 1}^{M} {b}_{i} {z}_{i} & ( 3 ) \\ {b}_{i} = \vert {b}_{i} \vert \cdot {ⅇ}^{{jϕ}_{i}} ; {z}_{i} = {ⅇ}^{{α}_{i} + {jω}_{i}} & \end{matrix}$$

In equation 1, Y(k) is the measured signal; x(k) is the pure signal; n(k) is the additive noise and the k index represents time. The signal x(k) is modelled as a series of sinusoids which are damped or undamped.

In equations 2 and 3, |bᵢ| is the amplitude; αᵢ is the damping factor; φᵢ is the phase and ωᵢ is the frequency of each component. zᵢ are the signal poles.

All matrix processing methods mentioned previously rely on the above model to represent the measured signal. However, as indicated above, each matrix processing method has subtle differences and consequently process the data in slightly different ways. The first two parameters, frequency and damping factor, are found by determining the signal poles for each method. The amplitude and phase are then solved by summing the zᵢ's together to form an artificial signal and finding a least squares fit between the original signal and this artificial signal.

An advantage that the matrix processing methods have over the frequency technique is that they all incorporate multiple damping factors, whereas the FT is unable to distinguish between decaying or non-decaying signals. In the NQR technique, matrix processing methods may seem to give an advantage, as signals can be considered to be a composite of two types: free induction decay (FID) and echo shapes. Both of these signals have well defined shapes, as a FID is characteristically a decaying sinusoid and an echo has a Gaussian envelope shape, or in other words two FID's which are placed back-to-back.

However in practical NQR detection devices the steady state type signals received offer almost no damping characteristics. In other words the signals received from an NQR detection device appear to be undamped sinusoids. This fact makes the damping factor of limited value for detection of signals. Hence, the damping factor may only be useful in removing magnetoacoustic, piezoelectric and electronic item emissions, although some of these signals also appear to be non-decaying.

This problem limits the use of the matrix processing methods in practice using NQR practical detection.

### DISCLOSURE OF THE INVENTION

An object of the current invention is to improve the analysis of signals received from an object.

An object of an optional, although not essential, aspect of the present invention is to improve the utility of the use of matrix processing methods in the detection of NQR signals using NQR detection techniques.

An object of an alternate optional, although not essential, aspect of the present invention is to improve the utility of the use of frequency processing methods in the detection of NQR signals using NQR detection techniques.

In accordance with one aspect of the present invention, there is provided a method for analysing signals received from an object, comprising: deriving frequency and phase parameters from said signals in either the time domain or frequency domain; and identifying whether said signals conform to a prescribed linear relationship between the two parameters to ascertain whether a true signal representative of a character of said object is present.

Preferably, the correlating is performed by plotting said parameters as two variables against each other.

In this manner, the statistical false alarm rates of signals analysed in the time domain may be improved by approximately 90%, compared with previous methods described above in the background art. Frequency domain techniques may also be improved by incorporating the correlation between frequency and phase.

Preferably, the method includes cross-correlating amplitude in conjunction with correlating the frequency and phase of an analysed signal.

In this manner false alarm rates may be reduced and/or detection rates improved further.

In accordance with another aspect of the present invention, there is provided a signal processing apparatus for analysing signals received from an object comprising:
parameter derivation means to derivate the frequency and phase parameters in either the time domain or frequency domain of the signal being analysed;
processing means to compare said frequency and phase parameters against a prescribed correlation of frequency and phase; and
identifying means to identify whether said parameters conform to a prescribed linear relationship between the two parameters to ascertain whether a true signal representative of a character of said object is present.

In accordance with a further aspect of the present invention, there is provided a method for analysing signals received from an object, comprising:
receiving data signals in respect of said object;
dividing said data into a plurality of smaller datasets;
processing said smaller datasets in the time domain or the frequency domain to derive signal parameters for all or the majority of said datasets;
comparing said signal parameters with predetermined references; and
identifying whether said signal parameters fall within prescribed limits with respect to said predetermined references to ascertain whether a true signal representative of a character of said object is present.

Preferably, the processing of the smaller datasets in the frequency domain is performed using Short Time Fourier Transform (STFT), and in the time domain is performed using Short Time Matrix Processing Method (STMPM).

In accordance with a still further aspect of the present invention, there is provided a method for reducing false alarms in the detection of nuclear or electronic resonance signals from a material, comprising analysing the time, amplitude or FFT for each signal to be added to the cumulative signal to determine if it has an excessively large amplitude; and if it has an excessively large amplitude excluding it from being added to said cumulative signal.

### BRIEF DESCRIPTION OF THE DRAWINGS

FIG. 1: shows a plot of the frequency and phase correlation of signals derived from the MMPM method for M=2 in accordance with the first mode.

FIG. 2: shows a plot of the frequency and phase correlation of signals derived from the MMPM with no signal present, i.e. random noise.

FIG. 3: shows the reduction in false alarm rates for a constant detection rate of 85% for M=4 and M=8.

FIG. 4: shows a flow diagram of the detection process.

FIG. 5: shows a frequency-phase unwrapped plot for PETN signals, processed through the MMPM, where the signals were measured under varying temperature.

FIG. 6: shows the STFT of a signal that contained an explosive material in accordance with the second mode.

FIG. 7: shows the STFT of a signal that contained noise and ordinarily would have produced a false alarm in accordance with the second mode.

FIG. 8a: is a graph showing how the frequency tracks through time for an explosive sample in accordance with the second mode.

FIG. 8b: is a graph showing the frequency for 190 datasets for a noisy sample in accordance with second mode.

FIG. 9: is a flow chart showing the decision making process in accordance wit the second mode.

FIG. 10: shows the decision making process for removing noisy samples from the global signal average in accordance with a third mode.

FIG. 11: shows the voting system employed when two or more FFT/matrix processing methods are used to determine the signal's parameters in accordance with the fourth mode.

FIG. 12: shows the method to combine two parameters to form a new parameter in accordance with the fourth mode which can then be processed through the first embodiment of the invention.

FIG. 13: shows the concentric ellipses which can be used to weight the parameters resulting from the use of any of the processing methods described.

### MODE(S) FOR CARRYING OUT THE INVENTION

To be of use in practical NQR measurements, matrix processing methods need to be able to detect substances at a better detection rate and/or lower false alarm rate (FAR) than the current traditional FT techniques. As most signals from practical NQR devices look like almost pure sinusoids, previously it was considered that certain matrix processing methods were not suitable for NQR detection purposes.

To illustrate this problem, a non-decaying sinusoidal signal was added to 100 random noise realisations and processed a thousand times through each of six different matrix processing methods and an FFT method to determine the probability of detection. This process was then repeated without the signal present to determine the false alarm rate.

With the signal present this corresponded to a very noisy signal with a low SNR (˜9.5 on average) in the FFT frequency spectrum. The SNR was calculated by taking the peak height within a signal window and dividing this by the mean of the noise either side of the signal window. The detection window was 11 kHz wide corresponding to what may be expected in a worst case scenario in NQR detection due to temperature variations, as NQR frequencies shift with temperature. For each processing method the signal was bandpass filtered to only include the frequency window of interest and decimated by a factor of 8 to increase processing speed. The use of the bandpass filter helps to bias the matrix processing methods to find only signals that occur within the frequency window, rather than large signals outside the frequency window. The decimation was required because the SVD used in all of the methods takes a long time to process large matrices.

Table 1 below shows a comparison of the probability of detection (PD) and the false alarm rate (FAR) for the six matrix processing methods and the FFT method that were considered, with the matrix processing methods being examined at 1, 2, 4, and 8 signal components (M).

Ideally the probability of detection should be 100% and the false alarm rate should be 0%. However, in a practical NQR detector this cannot be achieved, which means that the probability of detection would be below 100% and the false alarm rate would be above zero percent.

In the methods presented in Table 1, the PD was selected to be 85%, not an ideal probability of detection but one that enables comparison of the improvement in false alarm rates for the different detection methods.

TABLE 1

| | False | False | False | Percentage Reduction |
|---|---|---|---|---|
| | Alarm Rate | Alarm Rate | Alarm | in the False Alarm |
| Method | (%)* | (%)^{§} | Rate (%)^{†} | Rate (%) |
| FFT | 0.1 | 0 | — | — |
| M = 1 | | | | |
| ESPRIT | 4.5 | — | — | — |
| MPFOC | 0.3 | — | — | — |
| HTLS | 2.4 | 0.4 | 0.1 | 96 |
| HSVD | 2 | 0.5 | 0.1 | 95 |
| MPM | 1.9 | 0.4 | 0.2 | 89 |
| MMPM | 1.3 | 0.1 | 0.1 | 92 |
| M = 2 | | | | |
| ESPRIT | 9.9 | — | — | — |
| MPFOC | 0.8 | — | — | — |
| HTLS | 2 | 0.3 | 0.3 | 85 |
| HSVD | 2.5 | 0.6 | 0.3 | 88 |
| MPM | 2.6 | 0.5 | 0.3 | 88 |
| MMPM | 2.9 | 0 | 0.1 | 97 |
| M = 4 | | | | |
| ESPRIT | 20.5 | — | — | — |
| MPFOC | 2.3 | — | — | — |
| HTLS | 3.4 | 0.5 | 0.4 | 88 |
| HSVD | 5.1 | 1 | 0.6 | 88 |
| MPM | 4.3 | 0.7 | 0.4 | 91 |
| MMPM | 4.7 | 0.7 | 0.5 | 89 |
| M = 8 | | | | |
| ESPRIT | 49.5 | — | — | — |
| MPFOC | 5.1 | — | — | — |
| HTLS | 6.9 | 1.7 | 0.5 | 93 |
| HSVD | 11.8 | 2.4 | 0.8 | 93 |
| MPM | 12.8 | 2.8 | 1.1 | 91 |
| MMPM | 6.9 | 1 | 0.7 | 90 |

*Incorporating limits on parameters only.
^{§}Incorporating limits on parameters and frequency-phase detection.
^{†}Incorporating limits on parameters, frequency-phase detection and cross correlation amplitude.

Column 1 of Table 1 shows the FAR for each matrix processing method used, where the FAR was derived by plotting a family of receiver operating characteristic (ROC) curves by varying the limits on the amplitude, phase, and damping factor parameters only to find the lowest possible false alarm rate at a detection rate of 85%. The FFT false alarm rate was determined by simply plotting a single ROC curve and reading off the false alarm rate at a detection rate of 85%.

It can be seen in this column that all matrix processing methods are slightly inferior when compared to the FFT, as all matrix processing methods have higher false alarm rates. The false alarm rate for the ESPRIT method is extremely high, which makes this method of no practical use. The other point to note is that as M is increased, the FAR increases, which is due to the fact that as more components are detected within the frequency window the greater the likelihood that there will be a noisy signal which will look like a real signal.

These relatively high FAR's from the matrix processing methods normally make such methods impractical to use for NQR detection purposes.

One mode of the invention is directed towards a signal processing technique and apparatus suitable for detecting signals emanating from a substance responsive to NQR, the technique and apparatus involving determining a correlation between parameters derived from matrix or frequency processing methods so as to improve the utility of using these methods for NQR detection purposes.

Correlations can be found by plotting the parameters against each other. Accordingly, a first embodiment of this mode of the invention is directed towards deriving frequency and phase parameters of signals detected from irradiating a substance with RF energy and correlating these parameters by plotting them. Plotting frequency and phase reveals the existence of more or less a linear relationship between the two parameters when signals derived from NQR are processed.

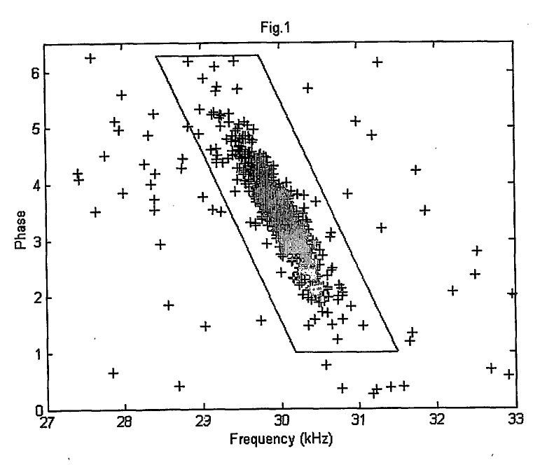

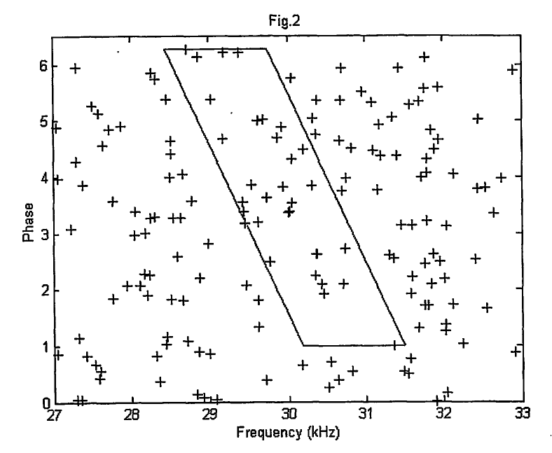

As indicated in FIG. 1, after plotting the frequency and phase of 1000 simulations of the non-decaying sinusoidal signal added to noise, it is apparent that a linear relationship exists between the two parameters for the majority of these simulations. As shown in FIG. 2, when plotting the same for just random noise data without the sinusoidal signal, there is no relationship. This fact can be exploited to aid detection of NQR signals by ascertaining only those signals falling within a specified region on the frequency-phase plot, as being possibly representative of true detected NQR signals. Any signals, or points representative of these signals, outside this area are not considered as a valid detection.

In the 2nd column of Table 1, the results derived from using the simulation process again with each of the processing methods, but this time with restrictions on the frequency and phase having a linear relationship, as well as restrictions on the damping factor, phase and amplitude parameters, are listed.

As can be seen the results show an improvement in the false alarm rate for all components of all matrix processing methods. This is evidenced in FIG. 1, whereby the majority of the signal measurements lie within the highlighted region, whereas in FIG. 2 the majority of the false alarm data lie outside the region. It should be noted that neither the ESPRIT nor the MPFOC methods produced a correlation between the frequency and phase, and therefore this particular signal processing technique, per se, cannot be used on these methods.

The present embodiment also includes biasing the results to increase the amplitude of the signal by cross-correlating the signal with a known signal. The amplitude parameter, as derived by each processing method, is replaced by the amplitude derived after processing the cross-correlated signal. This method biases the signal towards a signal with the correct shape and correct phase. Incorporation of this cross-correlation amplitude further reduces the false alarm rate of all matrix processing methods.

The importance of these techniques cannot be overemphasized because it allows detection of real explosives without many inconvenient false alarms occurring, which in the case of detecting explosives in luggage means much less hand searching of luggage arising from a false alarm.

An additional benefit is that it is now possible to set the M parameter to 4 or 8 without suffering a high false alarm rate. This is important because the number of signal components should be set reasonably high to account for situations where there are multiple signals present in the frequency window, so they can be correctly modelled. Failure to do so will result in explosive detections being missed.

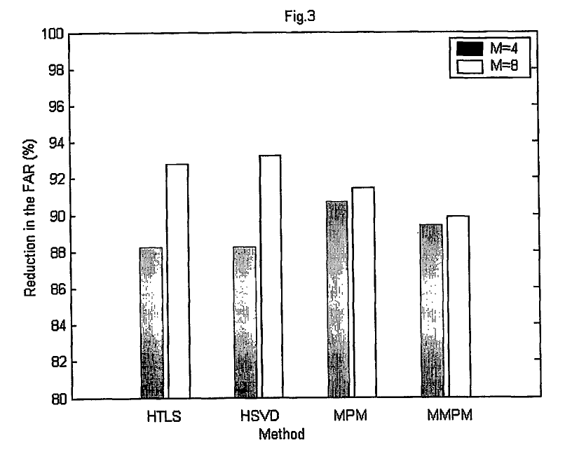

According to the present embodiment, after implementing both the frequency-phase detection technique and the cross-correlation of the signal for amplitude enhancement, the average reduction in the FAR for a constant detection rate of 85%, is 91% for all of the matrix processing methods, except ESPRIT and MPFOC. The improvements in the false alarm rate for each individual matrix processing method is shown in FIG. 3.

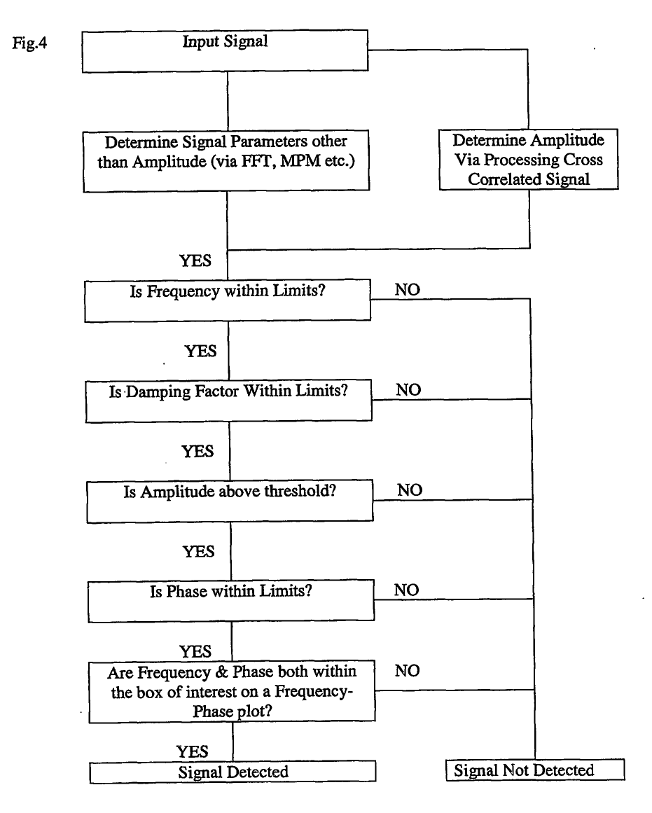

A specific example of the signal processing method used in a signal processing apparatus according to the present embodiment is shown by FIG. 4. The input is processed through one of the FFT, MPM, HTLS, HSVD or MMPM methods, with the amplitude determined separately for each method, except for the FFT. For each matrix processing method the M value is set to an appropriate value. Then the signal parameters are compared to reference values to determine if the signal detected lies within pre-described limits. Lastly the frequency and phase are compared to a frequency phase plot to determine if their values lie within a certain region on the frequency phase plot. If they do, then the signal is considered a real signal rather than noise, i.e. magnetoacoustic or piezoelectric signal.

The signal processing apparatus for performing the aforementioned signal processing method is simply implemented within a computer using appropriate hardware and software to provide parameter derivation means for deriving the frequency and phase parameters in either the time domain or frequency domain of the signal being analysed. The hardware and software also provide correlating means for correlating the frequency and phase parameters and identifying means for identifying whether a linear relationship exists between the two parameters to ascertain whether a true NQR signal has been detected.

The computer hardware and software required to perform each of the functions required to implement the signal processing method described in the present and subsequent embodiments is designed in accordance with conventional computer hardware and software processes and will not be described further.

The above embodiment was shown by way of example, and it would be quite simple to compare more than two correlated parameters on a plot in another embodiment. Thus in a second embodiment, a three dimensional plot of frequency, phase and damping factor is produced and then only measurements having these three signal parameters lying within a specified volume of this 3D plot count as an actual detection.

In other embodiments, multiple 2 or 3 dimensional plots are produced, whereby only those signals having the aforementioned signal parameters lying within prescribed areas or volumes on these plots count as detections.

In further embodiments, parameter plots are provided, whereby signals that have parameters lying within a specified area or volume of the parameter plot are excluded. An example of this is where a magnetoacoustic ringing signal that has very specific characteristics, is excluded.

According to a third specific embodiment, the frequency-phase detection method described in the preceding embodiments is applied to the FFT, to improve the detection rates and false alarm rates. Before this technique can be applied, the signal must be zero padded to at least 8,192 or higher number of points to provide enough resolution in the frequency domain so that the region of best fit can be identified and some spread in phase values of the random noise can be achieved. Linear interpolation of the frequency and phase are also used to determine these parameters.

Using this method with the same random data analysed by the matrix type methods previously described, the signal false alarm rate drops to only 0% for a detection rate of 85%. At a 95% detection rate the false alarm rate dropped from 1.6% to 0.1%, which was a 94% improvement in the false alarm rate, similar to what was achieved with the matrix processing methods.

These results indicate that the FFT frequency-phase method is far superior to all other methods. Nevertheless there may be applications where one of the matrix processing methods may be more suitable, for instance free induction decays have a distinctive damping factor, unlike the purely undamped sinusoidal signals modelled here. In this case the FFT would not be suitable for detection as it is unable to distinguish a sinusoid from a decaying FID.

Notwithstanding the previously described embodiments, one possible problem associated with implementing the technique of the best mode described herein, is the effect of temperature. All explosive detection NQR resonance frequencies move with temperature. For instance, the highest RDX frequency near room temperature moves at approximately 470 Hz/° C. This means that across a 40 degree temperature range, the frequency will drift 18.8 kHz. Fortunately most other NQR resonance frequencies have lower temperature coefficients, which in turn means the frequency changes will be smaller.

Thus, in another embodiment of the one mode of the invention, provision is made for a ‘best guess’ at the expected temperature of a sample to help narrow the temperature range and hence the frequency window of interest for detection purposes.

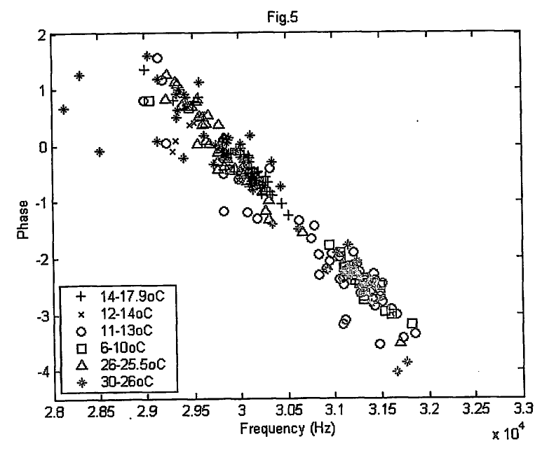

FIG. 5 shows an unwrapped phase plot of varying the temperature when measuring PETN with a fixed transmit frequency close to the resonant frequency of the nuclei. Circles and squares in this figure represent measurements performed between 6-13° C. Other measurements were measured performed from 14-30° C.

It should be apparent that the only effect of temperature is to increase the length of the region of interest. By suitably defining limits for the unwrapped phase, use of the frequency-phase technique still creates an improvement in the reduction of the false alarm rate.

It should be noted that correlating the frequency and phase enables the phase to be used, regardless of its value, across all temperatures and thus improvement in the false alarm rate can be achieved, notwithstanding temperature effects.

It should be appreciated that two of the largest contributors to the false alarm rate in both detecting explosives in airport luggage and buried landmines, are magnetoacoustic and piezoelectric ringing. Within airport luggage, electronic items can also cause unwanted signals.

Magnetoacoustic signals occur at a variety of frequencies near the signal of interest. Distinguishing them from real signals by frequency and amplitude discrimination alone is a virtually impossible task as they occur within the frequency window of interest. However, using the damping factor can help the situation, although few signals have a characteristic decaying signal.

Using the frequency-phase detection technique of the present mode can help because some of the signals returned from magnetoacoustic and electronic items have a random phase that differs from signals returned from explosives. Standard cross-correlation FFT threshold techniques for PETN measurement on a set of bags containing electronic items gave 16 false alarms out of 51 measurements. Using the MPM frequency-phase detection method in accordance with the first embodiment reduced this to 3 alarms and using the FFT frequency-phase method there were 8 alarms.

This last false alarm rate being higher than what could be achieved for MPM frequency-phase technique suggests that the FFT frequency-phase technique does not remove false alarms as well as the MPM frequency-phase technique. This can be attributed to two factors. The first factor is that even though the signal appears to be non-decaying, the MPM assigns some of the signals found with small negative damping factors resulting in these signals being rejected. The second is that in the MPM method the M parameter was set to 2, which allowed only two components to be found. The FFT, however, will find all sinusoid components within the frequency window, which results in an increased chance that a random signal of the correct phase will be found, thus increasing the false alarm rate.

The damping factor problem cannot be overcome for the FFT case because there is no provision for it in the FT model. The fact that there are numerous peaks in the frequency window can be overcome by determining which peaks in the frequency window seem significant, i.e. those that cross a specified threshold and determining their individual phase. If their phase is found to lie within the nominated area on the frequency-phase plot then they are accepted as a possible detection otherwise they are rejected as being noise, magnetoacoustic or piezoelectric signals. This method is a ‘phase based detection’, rather than a standard amplitude based detection, although the amplitude is still required to separate noise from real signals. In reprocessing the same data via the FFT frequency phase detection method described according to the third embodiment, the number of false alarms dropped to 6 from 8, indicating that the method was successful in rejecting some peaks with incorrect phase.

Table 2 shows the results of detecting PETN samples within a large coil NQR spectrometer. After optimising the parameters for each signal processing method, there appears very little difference between all methods, except that the traditional method of processing via the FFT alone produces the worst results. All other methods offer slightly better results. MPM, HTLS & HSVD frequency-phase methods in particular produced a zero false alarm rate, whereas the FFT frequency-phase method and the MMPM3 produced slightly higher detection rates. Hence the user could select the method of choice for processing based upon whether he required low false alarm rates or high detection rates.

TABLE 2

| | Large Mass | Small Mass | Medium Mass | Luggage |
|---|---|---|---|---|
| Method | Petn | Petn | within Luggage | Only |
| Standard | 50/50 | 16/50 | 76/100 | 4/100 |
| FFT | | | | |
| FFT Freq- | 49/50 | 21/50 | 87/100 | 3/100 |
| Phase* | | | | |
| MPM Freq- | 49/50 | 16/50 | 84/100 | 1/100 |
| Phase | | | | |
| HTLS Freq- | 48/50 | 15/50 | 85/100 | 0/100 |
| Phase | | | | |
| HSVD Freq- | 49/50 | 15/50 | 84/100 | 0/100 |
| Phase | | | | |
| MMPM3 | 49/50 | 22/50 | 84/100 | 3/100 |
| Freq-Phase | | | | |

*Using ‘Phase Detection’

A second mode of the invention is directed towards a signal processing technique suitable for detecting signals emanating from a substance responsive to NQR, using the Short Time Fourier Transform (STFT) processing method or the Short Time Matrix Fourier Transform (STMFT) processing method. The technique involves determining relevant signal parameters using these processing methods and determining whether they lie within predetermined limits to indicate whether the detected signal is true for a NQR signal emitted from an irradiated substance or false.

STFT is identical to an ordinary FFT, except that the fourier transform is performed upon successive subsets of the time data. By plotting the fourier transform for each successive subset it is possible to build up a picture over time of how the signal changes in frequency, amplitude and/or phase. The STFT technique is most useful for detecting when a signal changes frequency. These changes cannot be identified from an ordinary FFT.

Accordingly, the first embodiment of the second mode is directed towards using a STFT for processing signals received from a material irradiated with RF energy to stimulate NQR in a substance responsive to same.

The Short Time Fourier Transform (STFT) processing method of the present involves performing a multiple of FFT's on small sections of the sampled data received from a coil after irradiating the material to determine signal parameters for all of the majority of the sampled dataset. The signal parameters are then analysed to ascertain whether they lie within predetermined limits and a decision made as to whether they represent noise or possibly a true NQR signal.

Applying the STFT in this manner is particularly effective at distinguishing interference signals from real NQR signals. Noise that originates from electronic items and magnetoacoustic ringing usually does not extend all the way across the data sampling window or it has variable phase and/or frequency. On the other hand, NQR signals usually extend all the way across the data sampling window to maximise signal strength and have a constant phase and frequency. Hence, by using cross-correlated data in conjunction with the STFT, noise can be effectively discriminated from real NQR signals, resulting in a large reduction in the false alarm rate.

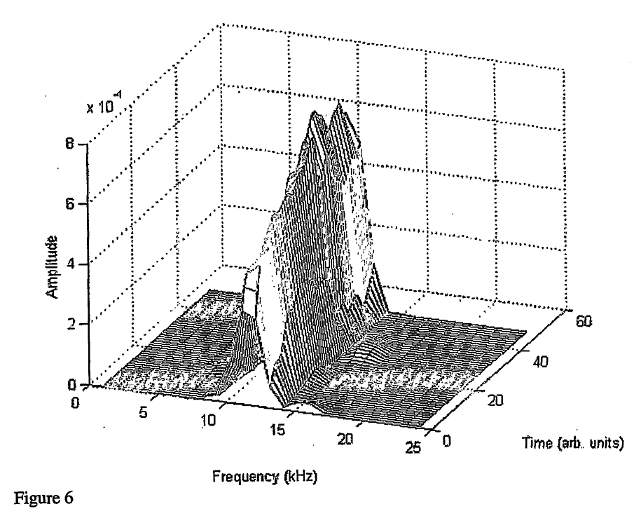

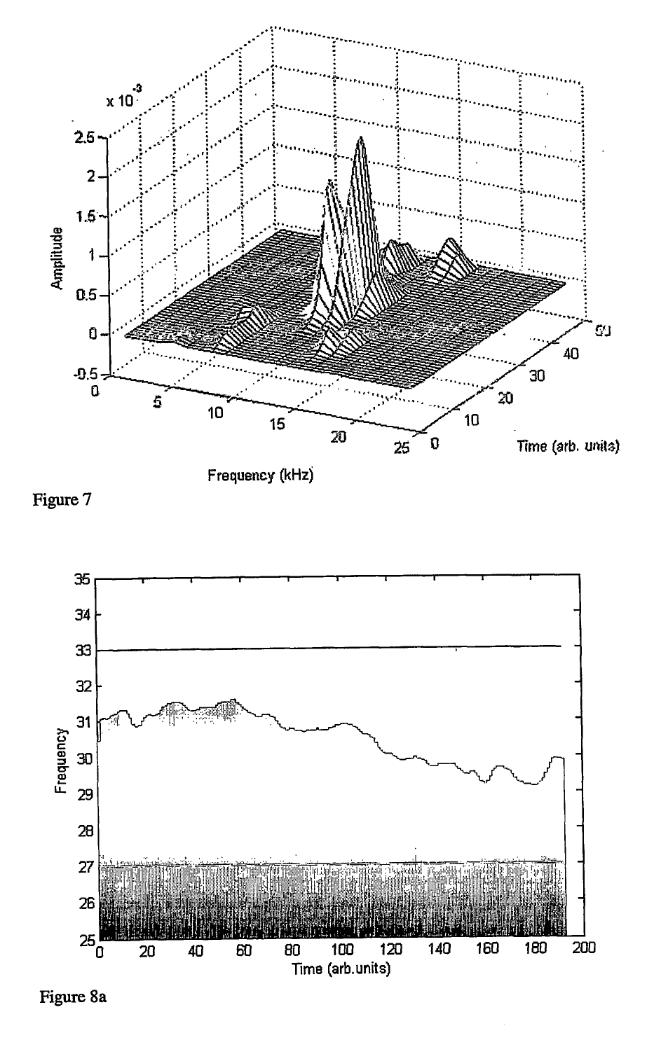

FIG. 6 shows the time-frequency plot of a signal generated from a NQR explosive sample and FIG. 7 shows a similar time-frequency plot from a signal that gave a false alarm during ordinary cross-correlation FFT analysis.

In both cases the original data was divided into multiple overlapping half length data sets which were processed through a standard cross-correlation detection routine. In each figure there were 190 small time datasets analysed. To account for the fact that each dataset has a slightly different starting phase, by virtue of starting on a different point of the sinusoid, the phase was incremented according to the expected frequency and the number of points contained in one cycle at that frequency. It can be seen that the noise signal does not extend all the way along the time data and can be removed by appropriate thresholding, whereas the NQR signal extends entirely along the time window, which allows easy discrimination between the two.

The use of this method resulted in the reduction of the false alarm rate of real airport luggage by approximately 75%, which is a significant improvement. Using this same method the detection rate was unchanged.

This same method can be adapted to matrix processing techniques. Accordingly, a second embodiment of the present mode is directed towards forming a ‘Short Time Matrix Processing Method’ (STMPM), whereby a small section of data is analysed with matrix processing techniques such as the MPM. Similar to the standard STFT, this method produces a time-frequency plot in which it is possible to distinguish time-frequency effects.

The data that was analysed in the short time fourier transform section in the previous embodiment was re-analysed using this new STMPM method of the present embodiment. That is the data was broken into 190 overlapping datasets and each dataset was processed through using the FFT frequency-phase method. After each of the 190 datasets, a frequency, phase and amplitude parameter are produced. The frequency, phase and amplitude parameters are tracked to identify how these change during the measurement.

Unlike previous methods of the preceding mode, in this method there exists no correlation between frequency and phase within each time series, however, from sample to sample the frequency-phase correlation will still exist. Because the FFT frequency phase and other matrix methods produce parameters rather an amplitude function that can be plotted versus frequency, the parameters are thresholded within limits. If any of the parameters lie outside the prescribed limits for any of the 190 datasets then the sample is rejected as being noise rather than a real sample.

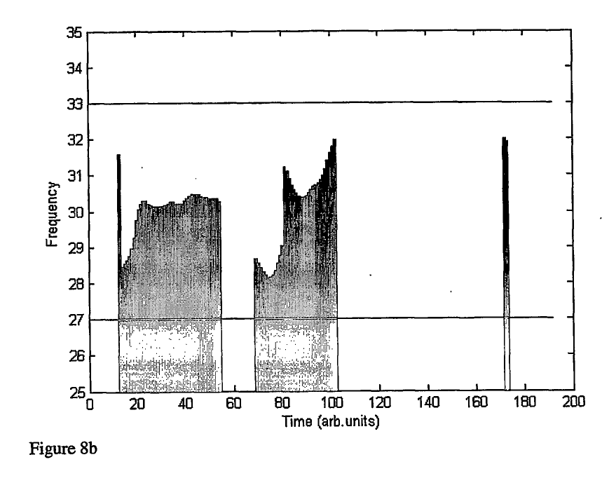

FIG. 8a shows how the frequency tracks through time for an explosive sample. It can be seen the frequency is present in each of 190 datasets.

FIG. 8b shows the frequency for 190 datasets for a noisy sample. It can be seen that the frequency is not detected inside a pre-described window in part of the 190 datasets and therefore this sample is probably noise and is rejected.

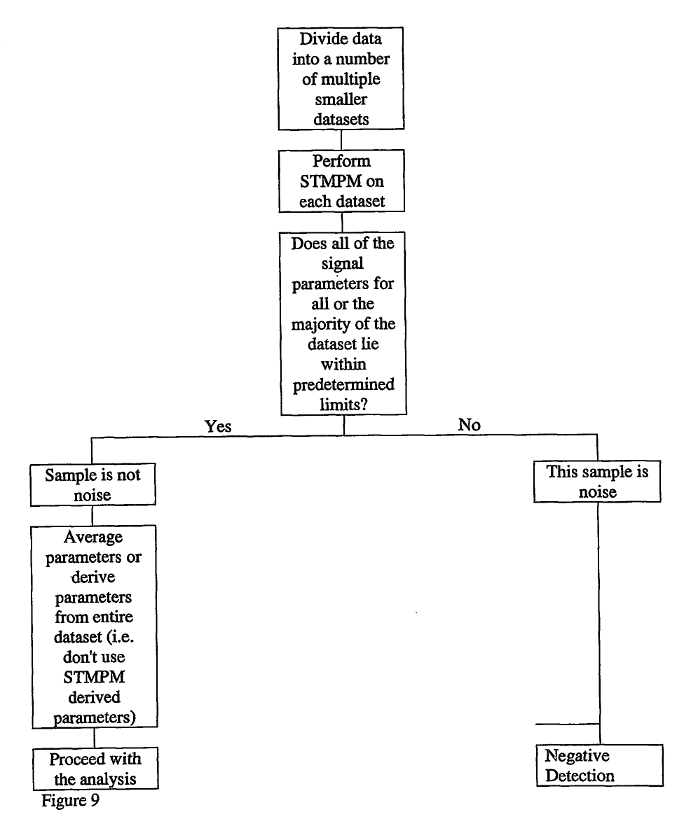

FIG. 9 shows the decision making process for this embodiment. If the sample survives this first rejection using the STMPM processing method, the phases, amplitudes and frequencies can be averaged to produce a global result for the sample or the parameters can be derived from the entire dataset using normal matrix method processing, but not using the STMPM. The averaged or non STMPM derived frequency and phase can then be plotted to determine if they lie within a prescribed area. If they do then they are counted as a detection otherwise they are rejected as being noise.

In the process of collecting NQR data from a coil, many thousands of signals are averaged together on an analog-to-digital (ADC) card or inside a computer to produce enough signal which is then processed via an FFT or other methods. However, during this process a few of these signals included in this average may include very large signals from electronics, magnetoacoustic or piezoelectric ringing. These large signals dwarf the many smaller NQR signals and thus dominate the final average. Hence, in yet a third mode of the present invention there is provided a signal processing technique and apparatus for reducing false alarms in NQR involving analysing the time amplitude or FFT for each signal to be added to the cumulative signal to determine if it has an excessively large amplitude. If it has an excessively large amplitude it is not included in the final average as it is probably noise rather than a real NQR signal.

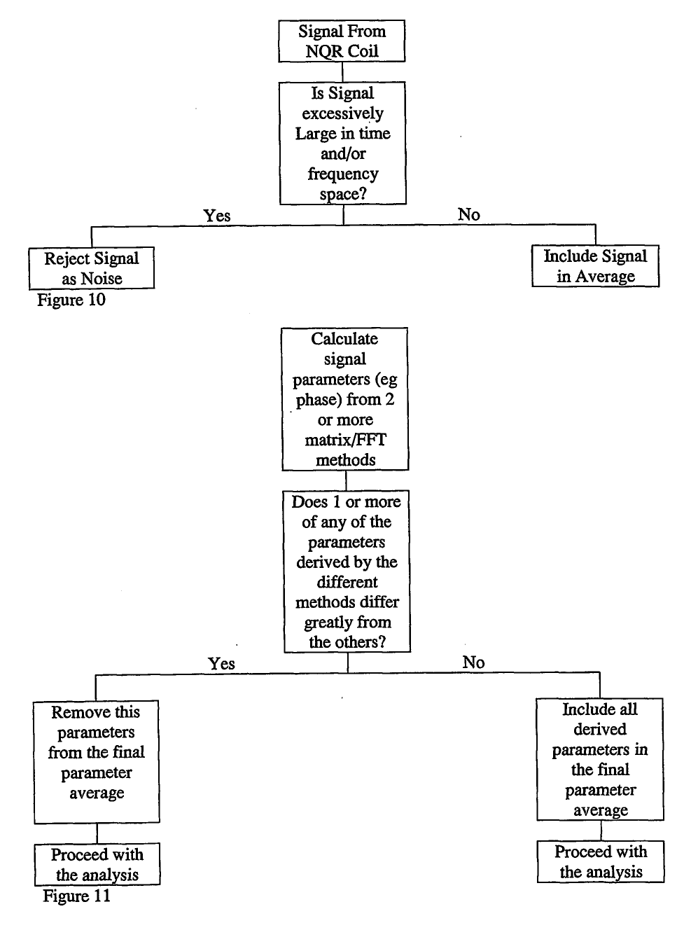

FIG. 10 displays the decision making process to remove noise from the final averaged signal.

In a fourth mode of the present invention, the results from the various signal processing techniques are combined or averaged to produce an overall superior detection method.

In a preferred embodiment of this mode, the parameters derived from all six methods in Table 2 are combined to provide a better result than if one technique was used by itself. The average frequency and phase obtained over the six methods may eliminate some more noise and allow a more reliable result.

In a further embodiment of the present mode, the processing technique of the previous embodiment is expanded to include a ‘voting’ system because of the number of different methods used for processing the same data. According to this embodiment, if one method produces strange results as compared to the other five, then this method would be removed from the average.

FIG. 11 displays the decision making process to arrive at the final averaged parameter for any one received signal.

It is also possible to combine parameters derived from any of the various methods into a single value. Accordingly, in another embodiment of the present mode, a number representing the phase result, ie phase_strength, is derived by determining how close it lies to a nominated value. If it lies a long way from the nominated phase then it is given a rating close to zero. If it lies close to the nominated phase it is given a rating of one. Similarly, the damping factor is rated by how close it lies to a nominated value and this new value is called the damping_factor_strength. These two factors are then combined either linearly or otherwise to form a new variable phase_and damping_factor_strength which is plotted against frequency to determine if it lies within a certain area of the graph. If it does lie within the nominated area then it is counted as a detection otherwise it is not a detection.

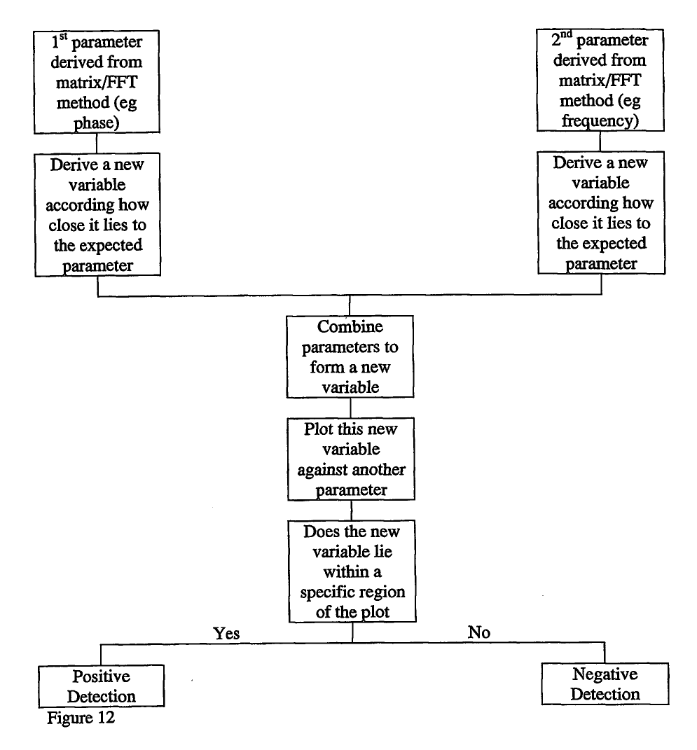

FIG. 12 displays the decision making process to arrive at the final new parameter for any one received signal. This method can be particularly useful when trying to avoid plotting into three dimensional graphs, which are more difficult to interpret than 2D graphs.

Furthermore, in FIG. 12 instead of defining a specific region, there is a weighting ‘hill’ over the region of interest. If the measured frequency and phase produce a point which lies near the top of the ‘hill’ then the result is given a high probability of being a real detection. If the point lies on the edge of the hill then it is given a low probability of detection. This method is effectively weighting the result. To extend this method further, the weighting factor produced by this method is applied against the amplitude produced by the processing so that a large amplitude signal on the edge of the hill can be detected equally as a small signal at the top of the hill. If a signal is small and on the edge of the hill then it will not be detected.

This technique is relevant for removing false alarms which have small amplitudes and are near the edges of the hill, and thus helps to reduce the false alarm rate.

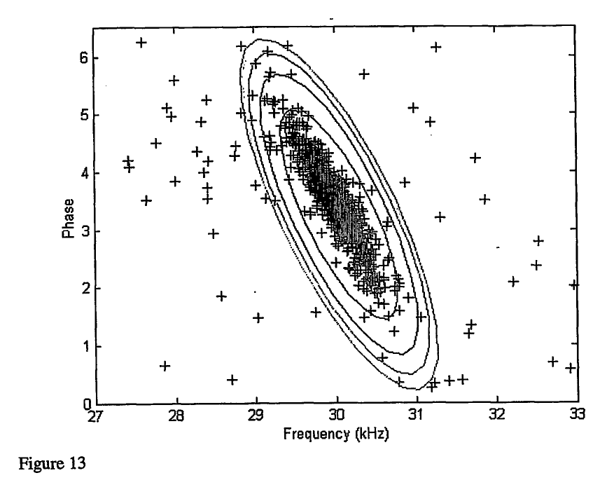

The technique is shown in FIG. 13 whereby the inner ellipse circumscribes the best data (and thus the best weighting) and the other ellipses circumscribe data that is progressively given lower weighting values.

It should be appreciated that the scope of the present invention is not limited to the specific embodiments described herein, and that the invention can have utility and effect with other signal processing techniques not specifically referred to herein. Accordingly, the extended application of the invention to these other signal processing techniques, although not expressly described herein, is still considered to fall within the scope of the invention. Furthermore, the signal processing techniques described herein could be used to analyse not only NQR signals, but nuclear magnetic resonance (NMR), electron spin resonance (ESR), geophysical, medical, financial and any other technique which requires the use of spectral analysis.

1. A method for analysing signals received from an object, comprising: deriving frequency and phase parameters from said signals in either the time domain or frequency domain; and identifying whether said signals conform to a prescribed linear relationship between the two parameters to ascertain whether a true signal representative of a character of said object is present.

2. A method as claimed in claim 1, wherein said parameters are derived from using a matrix processing method in the analysis of said signals.

3. A method as claimed in claim 2, wherein said parameters also include a damping factor, and the method includes identifying whether said damping factor is within prescribed limits relevant thereto consistent with said character to further ascertain whether said signal representative of said particular character is present in the material.

4. A method as claimed in claim 2, including identifying whether said frequency is within prescribed limits relevant thereto consistent with said character separately of said correlating to further ascertain whether said signal representative of said particular character is present in the object.

5. A method as claimed in claim 2, including identifying whether said phase is within prescribed limits relevant thereto separately of said correlating consistent with said character separately of said correlating to further ascertain whether said signal representative of said particular character is present in the object.

6. A method as claimed in claim 2, wherein said matrix processing method comprises Hankel Total Least Squares (HTLS), Hankel Single Value Decomposition (HSVD), Matrix Pencil Method (MPM), or Modified Matrix Pencil Method (MMPM).

7. A method as claimed in claim 1, including increasing the amplitude of the analysed signal by cross-correlating said analysed signal with a known signal separately of correlating the frequency and phase of said analysed signal, and identifying whether said amplitude exceeds a threshold consistent with said character to further ascertain whether said signal representative of said particular character is present in the object.

8. A method as claimed in, including:
receiving an input signal from an object;
processing said input signal through a signal processing method to produce signal parameters in respect thereof;
comparing the signal parameters derived from said signal processing method to reference values to determine if said input signal lies within prescribed limits;
comparing the frequency and phase parameters derived from said signal processing method to a reference correlation of frequency and phase to determine if the values of said frequency and phase parameters lie with a certain range where said linear relationship exists; and asserting said input signal as a real signal as opposed to noise if said values lie within said range.

9. A method as claimed in claim 8, wherein said parameters also include a damping factor, and the method includes identifying whether said damping factor is within prescribed limits relevant thereto consistent with said character to further ascertain whether said signal representative of said particular character is present in the material, and wherein said damping factor is a said signal parameter.

10. A method as claimed in claim 8, including identifying whether said frequency is within prescribed limits relevant thereto consistent with said character separately of said correlating to further ascertain whether said signal representative of said particular character is present in the object, and wherein said frequency is a said signal parameter.

11. A method as claimed in claim 8, including identifying whether said phase is within prescribed limits relevant thereto separately of said correlating consistent with said character separately of said correlating to further ascertain whether said signal representative of said particular character is present in the object, and wherein said phase is a said signal parameter.

12. A method as claimed in claim 8, wherein said signal processing method comprises a matrix processing method.

13. A method as claimed in claim 12 wherein said matrix processing method comprises Hankel Total Least Squares (HTLS), Hankel Single Value Decomposition (HSVD), Matrix Pencil Method (MPM), or Modified Matrix Pencil Method (MMPM).

14. A method as claimed in claim 13, including increasing the amplitude of the analysed signal by cross-correlating said analysed signal with a known signal separately of correlating the frequency and phase of said analysed signal, and identifying whether said amplitude exceeds a threshold consistent with said character to further ascertain whether said signal representative of said particular character is present in the object, and including determining the amplitude of said input signal separately of said processing by said cross-correlating.

15. A method as claimed in claim 8, wherein said signal processing method comprises a frequency processing method.

16. A method as claimed in claim 15, wherein said frequency processing method comprises Fast Fourier Transform (FFT) or Short Time Fourier Transform (STFT).

17. A method as claimed in claim 8, including varying said reference values and said reference correlation of frequency and phase to expected temperatures of the object.

18. A method as claimed in claim 1, wherein the correlating comprises plotting said frequency and phase parameters as two variables against each other to define a range within which said linear relationship exists.

19. A method as claimed in claim 18, wherein said parameters also include a damping factor, and the method includes identifying whether said damping factor, is within prescribed limits relevant thereto consistent with said character to further ascertain whether said signal representative of said particular character is present in the material, and wherein said damping factor parameter is plotted against said frequency and phase parameters as a 3D plot to define a volume wherein said parameters equate to said true signal.

20. A method as claimed in claim 18, including increasing the amplitude of the analysed signal by cross-correlating said analysed signal with a known signal separately of correlating the frequency and phase of said analysed signal, and identifying whether said amplitude exceeds a threshold consistent with said character to further ascertain whether said signal representative of said particular character is present in the object, and wherein said amplitude is plotted against said frequency and phase parameters as a 3D plot to define a volume wherein said parameters equate to said true signal.

21. A method as claimed in claim 18, including defining regions or volumes in said plot indicative of the parameters of a false signal not representative of said character, to facilitate in the ascertaining of a said true signal.

22. A method as claimed in claim 21, wherein said false signal is representative of magnetoacoustic or piezoelectric ringing.

23. A method as claimed in claim 1, wherein said character is representative of the existence of a prescribed substance in said object.

24. A method as claimed in claim 23, wherein said character is a nuclear or electronic resonance of said prescribed substance.

25. A method as claimed in claim 24, wherein said nuclear or electronic resonance is a nuclear quadrupole resonance (NQR), a nuclear magnetic resonance (NMR) or an electron spin resonance (ESR) of said prescribed substance.

26. A signal processing apparatus for analysing signals received from an object, comprising:
parameter derivation means to derivate the frequency and phase parameters in either the time domain or frequency domain of the signal being analysed;
processing means to compare said frequency and phase parameters against a prescribed correlation of frequency and phase; and
identifying means to identify whether said parameters conform to a prescribed linear relationship between the two parameters to ascertain whether a true signal representative of a character of said object is present.

27. A method for analysing signals received from an object, comprising:
receiving data signals in respect of said object;
dividing said data into a plurality of smaller datasets;
processing said smaller datasets in the time domain or the frequency domain to derive signal parameters for all or the majority of said datasets;
comparing said signal parameters with predetermined references; and
identifying whether said signal parameters fall within prescribed limits with respect to said predetermined references to ascertain whether a true signal representative of a character of said object is present.

28. A method as claimed in claim 27, including averaging said derived parameters or deriving said parameters from the entire dataset not using the previously derived parameters.

29. A method as claimed in claim 27, wherein said processing of said smaller datasets in the frequency domain is performed using Short Time Fourier Transform (STFT), and in the time domain is performed using Short Time Matrix Processing Method (STMPM).

30. A method for reducing false alarms in the detection of nuclear or electronic resonance signals from a material, comprising analysing the time, amplitude or FFT for each signal to be added to the cumulative signal to determine if it has an excessively large amplitude; and if it has an excessively large amplitude excluding it from being added to said cumulative signal.

31-32. (canceled)
